(19) United States
(12) Patent Application Publication
(10) Pub. No.: US 2013/0236282 A1
(43) Pub. Date: Sep. 12, 2013

(54) TRANSFERRING APPARATUS FOR LIQUID CRYSTAL PANEL

(71) Applicants: Hongtao Deng, Shenzhen (CN); Tsung-i Hung, Shenzhen (CN)

(72) Inventors: Hongtao Deng, Shenzhen (CN); Tsung-i Hung, Shenzhen (CN)

(73) Assignee: Shenzhen China star Optoelectronics Technology Co. LTD., Shenzhen, Guangdong (CN)

(21) Appl. No.: 13/520,344

(22) PCT Filed: Mar. 31, 2012
(86) PCT No.: PCT/CN12/73425

§ 371 Date: Jul. 3, 2012

(30) Foreign Application Priority Data
Mar. 9, 2012 (CN) 201220088305.9

(51) Int. Cl. B65G 1/133; B66C 1/02

(52) U.S. Cl. 414/752.1

(57) ABSTRACT

A transferring apparatus includes a main body, at least one suction cup, and a vacuum generating device. The main body is used for supporting a liquid crystal panel. The at least one suction cup is disposed in the main body and is adhered to the liquid crystal panel. The vacuum generating device is disposed in the main body and communicates with the at least one suction cup for generating negative-pressure gas when the at least one suction cup contacts the liquid crystal panel to allow the at least one suction cup to be adhered to the liquid crystal panel. With the vacuum generating device, the suction cup is capable of being adhered to the liquid crystal panel tightly, thus, the transferring apparatus can carry and transfer the liquid crystal panel stably after the liquid crystal panel contacts the suction cups, and further avoid damage to the liquid crystal panel.

### BACKGROUND

1. Technical Field

The present disclosure relates to transferring apparatus, and particularly, to a transferring apparatus for transferring a liquid crystal panel.

2. Description of Related Art

In assembling process of a liquid crystal display (LCD), a liquid crystal panel is often needed to be transferred between two adjacent assembling machines such that the liquid crystal panel can be assembled with other components of the LCD. Generally, in the process, the liquid crystal panel is placed on a conveyor disposed between the two adjacent assembling machines. Or sometimes, when the two assembling machines are close enough to each other, operators may transfer the liquid crystal panel by hand. However, with the development of the manufacturing technology of the LCD, the size of the liquid crystal panel has become larger and larger and a thickness thereof has become smaller and smaller, which may easily result in damage to the liquid crystal panel when the liquid crystal panel is transferred by the conveyor or by hand.

Therefore, there is room for improvement in the art.

### SUMMARY

One object of the present disclosure is to provide a transferring apparatus for carrying and transferring a liquid crystal pane. The transferring apparatus includes a main body, at least two suction cups, and a vacuum generating device. The main body is used for supporting the liquid crystal panel, and includes two connection rods facing each other. The at least two suction cups are respectively slidably disposed on the two connection rods. The vacuum generating device is disposed in the main body and communicating with the at least two suction cups, and is configured for generating and providing negative-pressure gas when the at least two suction cups contact the liquid crystal panel so that the at least two suction cups can be adhered to the liquid crystal panel stably.

Preferably, a sliding slot is defined in each of the connection rods, and each suction cup includes a connection member slidably disposed in the corresponding sliding slot.

Preferably, each connection rod includes a side facing the liquid crystal panel and defining the corresponding sliding slot.

Preferably, the connection member is substantially Z-shaped.

Preferably, each of the at least two suction cups further includes a suction portion and a connection shaft, the suction portion contacts the liquid crystal panel, and the connection shaft connects the suction portion and the connection member.

Preferably, the connection shaft is made of elastic material.

Preferably, the vacuum generating device includes a vacuum generator for providing the negative-pressure gas and a gas storage tank for storing the negative-pressure gas.

Preferably, the vacuum generating device further includes a detector, and the detector is disposed in the vacuum generator for detecting a gas pressure of the negative-pressure gas provided by the vacuum generator and displaying the detected value.

Preferably, the main body further includes at least one connection arm for connecting the two connection rods, the transferring apparatus further includes a handle disposed on the at least one connection arm.

Preferably, the main body is made of aluminum.

The present disclosure further provides another transferring apparatus. The transferring apparatus includes a main body, at least one suction cup, and a vacuum generating device. The main body is used for supporting a to-be-transferred object. The at least one suction cup is disposed in the main body and is adhered to the to-be-transferred object. The vacuum generating device is disposed in the main body and communicates with the at least one suction cup for generating negative-pressure gas when the at least one suction cup contacts the to-be-transferred object to allow the at least one suction cup to be adhered to to-be-transferred object.

Preferably, the at least one suction cup is slidably disposed in the main body.

Preferably, the main body defines at least one sliding slot, and each suction cup includes a connection member slidably disposed in the corresponding sliding slot.

Preferably, the main body includes a frame and at least one connection arm disposed on an inner side of the frame.

Preferably, the frame includes two first connection rods and two second connection rods, the two first connection rods face each other and are parallel with each other, each of the first connection rods includes a first side facing the other first connection rod and a second side perpendicularly connected to the first side and facing the to-be-transferred object; the two second connection rods face each other and are respectively connected to the first connection rods, and the sliding slot is defined in the second side of the corresponding first connection rod.

Preferably, the connection member is substantially Z-shaped.

Preferably, each suction cup includes a suction portion and a connection shaft, the suction portion is configured to contact the to-be-transferred object, and the connection shaft connects the suction portion and the connection member.

Preferably, the vacuum generating device includes a vacuum generator for providing the negative-pressure gas and a gas storage tank for storing the negative-pressure gas.

Preferably, the vacuum generating device further includes a detector, and the detector is disposed in the vacuum generator for detecting a gas pressure of the negative-pressure gas provided by the vacuum generator and displaying the detected value.

Preferably, the to-be-transferred object is liquid crystal panel.

With the vacuum generating device for supplying negative-pressure gas, the suction portion of each suction cup is capable of being adhered to the liquid crystal panel tightly, thus, the transferring apparatus of the present disclosure is capable of carrying and transferring the liquid crystal panel stably after the liquid crystal panel contacts the suction cups. In this way, damage to the liquid crystal panel can be avoided somewhat.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a transferring apparatus in one embodiment of the present disclosure.

FIG. 2 is similar to FIG. 1, but viewed from another angle.

FIG. 3 is schematic view showing how the transferring apparatus is used.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

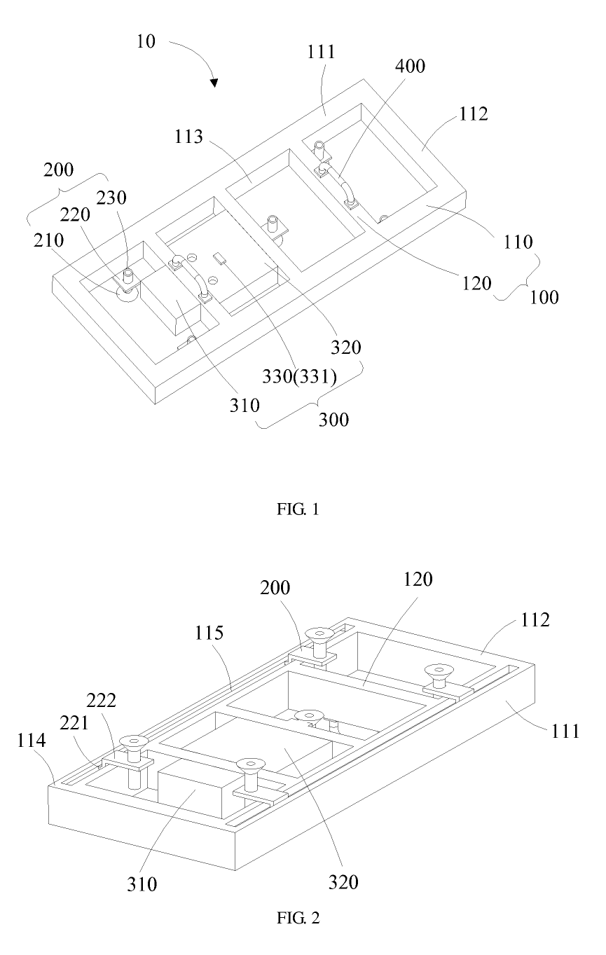

Referring to FIG. 1, a transferring apparatus 10, in one embodiment of the present disclosure, is shown. In an embodiment, the transferring apparatus 10 is used for transferring a liquid crystal panel so that the liquid crystal panel can be transferred between two adjacent assembling machines in the production line of a liquid crystal display (LCD). In other embodiments, the transferring apparatus 10 may be used for transferring other objects of appropriate weight or sizes. The transferring apparatus 10 includes a main body 100, five suction cups 200, a vacuum generating device 300, and two handles 400.

Referring also to FIG. 2, the main body 100 is used for supporting the liquid crystal panel and other components of the transferring apparatus 10. In some embodiments, the main body 100 includes a frame 110 and three connection arms 120 disposed on inner sides of the frame 110. The frame 110 includes two first connection rods 111 and two second connection rods 112. The two first connection rods 111 face each other and are parallel with each other. Each of the first connection rods 111 includes a first side 113 and a second side 114. The first side 113 faces the other connection rod 111. The second side 114 perpendicularly extends from the first side 113 and faces the liquid crystal panel. The second side 114 is recessed to define a sliding slot 115. The two second connection rods 112 are also configured to face each other and are respectively connected to the two first connection rods 111 to form the frame 110. Two ends of each connection arm 120 are respectively connected to the two first sides 113 of the two first connection rods 111.

The suction cups 200 are disposed on the main body 100 for sucking the liquid crystal panel and thus allowing the movement of the liquid crystal panel together with the transferring apparatus 10. In some embodiments, four of the five suction cups 200 are symmetrically respectively disposed on the two first connection rods 111, and the other one is disposed on one of the connection arms 120 such as the middle connection arm 120 in some embodiments. Each suction cup 200 includes a suction portion 210, a connection member 220, and a connection shaft 230.

The suction portion 210 is substantially funnel-shaped and is configured for being adhered to the liquid crystal panel. The connection member 220 is substantially Z-shaped, and includes an engaging portion 221 and an extending portion 222. The engaging portion 221 is substantially L-shaped and is capable of sliding in the corresponding sliding slot 115. The extending portion 222 extends from the engaging portion 221 and is substantially plate-shaped. The connection shaft 230 connects the suction portion 210 with the connection member 220, and one end thereof passes through and extends out the corresponding connection member 220. In some embodiments, the connection shaft 230 may be substantially cylindrical and is made of elastic material. In the assembly process, the engaging portion 221 of each suction cup 200 is clamped in the corresponding sliding slot 115, and one end of the corresponding connection shaft 230 away from the suction portion 210 passes through the hole (not shown) defined in the extending portion 222. The connection shaft 230 then can be screwed to the connection member 220 in rotation, thereby mounting each suction cup 220 to the main body 100.

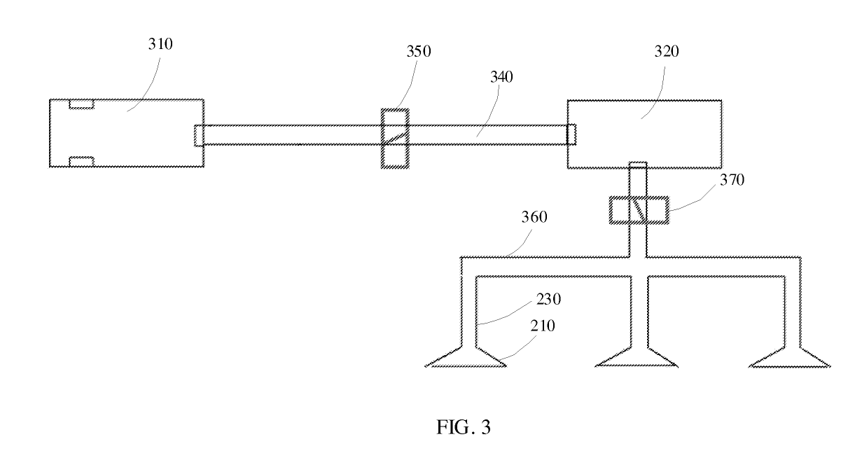

The vacuum generating device 300 is mounted in the main body 100 and connected to the suction cups 200. The vacuum generating device 300 is used for providing a negative-pressure gas condition in a space enclosed by each suction portion 210 and the liquid crystal panel, which keeps the corresponding suction cup 200 adhered to the liquid crystal panel. Referring to FIGS. 1 to 3, in some embodiments, the vacuum generating device 300 includes a vacuum generator 310, a gas storage tank 320, a detector 330, a first gas pipe 340, a first valve 350, a second gas pipe 360, and a second valve 370.

The vacuum generator 310 is used to generate negative-pressure gas. The gas storage tank 320 is used for storing the negative-pressure gas generated by the vacuum generator 310. The gas storage tank 320 communicates with the vacuum generator 310 through the first gas pipe 340, and communicates with the each suction portion 310 through the second gas pipe 360. The second gas pipe 360 is partly received in the connection shaft 230. In operation, after the negative-pressure gas is stored in the gas storage tank 320, the first valve 340 is closed and the second valve 360 is opened. Thus, the negative-pressure gas stored in the gas storage tank 320 can be supplied to the space defined by each suction portion 210 and the liquid crystal panel through the second gas pipe 360, which makes the gas pressure in the space be lower than atmosphere pressure, and thus allows the corresponding suction cup 200 to be adhered to the liquid crystal panel. The detector 330 is configured in the vacuum generator 310 for detecting the vacuum degree, that is, the gas pressure in the vacuum generator 310 and displaying the detected vacuum degree. In some embodiments, the detector 330 includes a display 331 disposed in the gas storage tank 320 for displaying the detected vacuum degree. The first valve 350 is disposed in the first gas pipe 340 for controlling on and off of the first gas pipe 340, and the second valve 370 is disposed in the second gas pipe 360 for controlling on and off of the second gas pipe 360.

The two handles 400 are respectively disposed on the connection arms 120 of the main body 100. Users can grasp the handles 400 when moving the transferring apparatus 10. In the embodiments, each handle 400 is disposed on a side of the corresponding connection arm 120 which face the second side 114 of the first connection rod 111.

In operation, the vacuum generator 310 can be turned on and the first valve 350 can be opened at first. The vacuum generator 310 generates negative-pressure gas which flows into the gas storage tank 320 through the first gas pipe 340 for storage. During the process of generating the negative-pressure gas, the detector 330 detects the gas pressure in the first gas pipe 340 and the display 331 displays the detected gas pressure. Users can determine the vacuum degree in the first gas pipe 340 via the display 331 and turns off the vacuum generator 310 when the vacuum degree reaches the predetermined value. The liquid crystal panel then can be placed on the transferring apparatus 10 with the suction portions 210 of the suction cups 200 contacting the liquid crystal panel. At this time, the second valve 370 can be opened to allow the space enclosed by the corresponding suction portion 210 and the liquid crystal panel to communicate with the gas storage tank 320. The negative-pressure gas thus is supplied to the space enclosed by each suction portion 210 and the liquid crystal panel. Since the gas pressure in the gas storage tank 320 is lower than atmosphere pressure, therefore, the suction cups 200 are capable of being adhered to the liquid crystal panel tightly under the pressure difference therebetween. At this time, the liquid crystal panel can be transferred stably and safely. After the liquid crystal panel is transferred to a predetermined location, the second valve 370 can be closed to allow air in the atmosphere to flow into the space, allowing the liquid crystal panel to be separated from the transferring apparatus 10 easily.

It is understood that in some embodiments, the main body 100 may be made of lightweight material such as aluminum.

It is understood that the main body 100 is not limited to this embodiment. In other embodiments, the main body 100 can be configured with the omission of the second connection rods 112. Similarly, the first connection rod 111 and the connection arm 120 are not limited to the embodiment, for example, the length of the first connection rod 111 can be adjusted according to different requirements, and the number of the connection arm 120 can be different according to the size or the weight of the to-be-transferred liquid crystal panel.

It is understood that the suction cup 200 can be slidably disposed or fixed in the middle connection arm 120.

It is understood that number of the suction cup 200 is not limited to the embodiment. In other embodiments, the number of the suction cup 200 can be adjusted according to the to-be-transferred liquid crystal panel. For example, the number of the suction cup 200 can be reduced when the liquid crystal panel to be transferred is relatively small and can be increased when the liquid crystal panel to be transferred can bear large adhered force from the suction cup 200.

It is understood that since each engaging portion 221 is slidably engaging with the corresponding sliding slot 115, therefore, an outer force can be applied to the connection member 220 to make the connection member 220 to slide in corresponding sliding slot 115 to adjust the position of the corresponding suction cup 200, which finally allows the transferring apparatus 10 to transfer liquid crystal panels of different sizes.

With the vacuum generating device 300, the suction portion 210 of each suction cup 200 is capable of being adhered to the liquid crystal panel tightly, thus, the transferring apparatus 10 of the present disclosure is capable of carrying and transferring the liquid crystal panel stably after the liquid crystal panel contacts the suction cups 200. Thus, damage to the liquid crystal panel can be avoided somewhat. Additionally, since the connection shaft 230 is made of elastic material, when the suction cup 200 is adhered to the liquid crystal panel, the connection shaft 230 can buffer the effect from the adhering force from affecting the liquid crystal panel, which can further prevent the liquid crystal panel from being damaged.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A transferring apparatus for carrying and transferring a liquid crystal panel, comprising:
a main body for supporting the liquid crystal panel, the main body comprising two connection rods facing each other;
at least two suction cups, being respectively slidably disposed on the two connection rods; and
a vacuum generating device disposed in the main body and communicating with the at least two suction cups, the vacuum generating device being configured for generating and providing negative-pressure gas when the at least two suction cups contact the liquid crystal panel so that the at least two suction cups can be adhered to the liquid crystal panel stably.

2. The transferring apparatus as claimed in claim 1, wherein a sliding slot is defined in each of the connection rods, and each suction cup comprises a connection member slidably disposed in the corresponding sliding slot.

3. The transferring apparatus as claimed in claim 2, wherein each connection rod comprises a side facing the liquid crystal panel and defining the corresponding sliding slot.

4. The transferring apparatus as claimed in claim 2, wherein the connection member is substantially Z-shaped.

5. The transferring apparatus as claimed in claim 2, wherein each of the at least two suction cups further comprises a suction portion and a connection shaft, the suction portion contacts the liquid crystal panel, and the connection shaft connects the suction portion and the connection member.

6. The transferring apparatus as claimed in claim 5, wherein the connection shaft is made of elastic material.

7. The transferring apparatus as claimed in claim 1, wherein the vacuum generating device comprises a vacuum generator for providing the negative-pressure gas and a gas storage tank for storing the negative-pressure gas.

8. The transferring apparatus as claimed in claim 7, wherein the vacuum generating device further comprises a detector, and the detector is disposed in the vacuum generator for detecting a gas pressure of the negative-pressure gas provided by the vacuum generator and displaying the detected value.

9. The transferring apparatus as claimed in claim 1, wherein the main body further comprises at least one connection arm for connecting the two connection rods, and the transferring apparatus further comprises a handle disposed on the at least one connection arm.

10. The transferring apparatus as claimed in claim 1, wherein the main body is made of aluminum.

11. A transferring apparatus, comprising:
a main body for supporting a to-be-transferred object;
at least one suction cup disposed in the main body and being adhered to the to-be-transferred object; and
a vacuum generating device disposed in the main body and communicating with the at least one suction cup for generating negative-pressure gas when the at least one suction cup contacts the to-be-transferred object to allow the at least one suction cup to be adhered to to-be-transferred object.

12. The transferring apparatus as claimed in claim 11, wherein the at least one suction cup is slidably disposed in the main body.

13. The transferring apparatus as claimed in claim 12, wherein the main body defines at least one sliding slot, and each suction cup comprises a connection member slidably disposed in the corresponding sliding slot.

14. The transferring apparatus as claimed in claim 13, wherein the main body comprises a frame and at least one connection arm disposed on an inner side of the frame.

15. The transferring apparatus as claimed in claim 14, wherein the frame comprises two first connection rods and two second connection rods, the two first connection rods face each other and are parallel with each other, each of the first connection rods comprises a first side facing the other first connection rod and a second side perpendicularly connected to the first side and facing the to-be-transferred object; the two second connection rods face each other and are respectively connected to the first connection rods, and the sliding slot is defined in the second side of the corresponding first connection rod.

16. The transferring apparatus as claimed in claim 13, wherein the connection member is substantially Z-shaped.

17. The transferring apparatus as claimed in claim 16, wherein each suction cup comprises a suction portion and a connection shaft, the suction portion is configured to contact the to-be-transferred object, and the connection shaft connects the suction portion and the connection member.

18. The transferring apparatus as claimed in claim 11, wherein the vacuum generating device comprises a vacuum generator for providing the negative-pressure gas and a gas storage tank for storing the negative-pressure gas.

19. The transferring apparatus as claimed in claim 18, wherein the vacuum generating device further comprises a detector, and the detector is disposed in the vacuum generator for detecting a gas pressure of the negative-pressure gas provided by the vacuum generator and displaying the detected value.

20. The transferring apparatus as claimed in claim 11, wherein the to-be-transferred object is a liquid crystal panel.
